(19) United States
(12) Patent Application Publication
(10) Pub. No.: US 2020/0103956 A1
(43) Pub. Date: Apr. 2, 2020

(54) HYBRID LOW POWER ARCHITECTURE FOR CPU PRIVATE CACHES

(71) Applicant: QUALCOMM Incorporated, San Diego, CA (US)

(72) Inventors: Raghavendra SRINIVAS, Blacksburg, VA (US); Satyaki MUKHERJEE, Bangalore (IN)

(21) Appl. No.: 16/146,153

(22) Filed: Sep. 28, 2018

(51) Int. Cl. G06F 1/32; G06F 3/06; G06F 9/30

(52) U.S. Cl. CPC G06F 1/3275; G06F 3/0625; G06F 3/0634; G06F 12/0897; G06F 9/3004; G06F 2212/1028; G06F 3/0683

(57) ABSTRACT

Systems and methods for memory power management based on allocation policies of memory structures of a processing system include entering a low power state for the processing system. The low power state includes one or more of a first, second, or third low power modes. In the first low power mode, for a first group of memory structures, periphery circuitry and memory cores are power collapsed. In the second low power mode, for a second group of memory structures, periphery circuitry is power collapsed and a retention voltage is provided to memory cores. In the third low power mode, a third group of memory structures are placed in an active mode. The first group includes strictly inclusive private caches, the second group includes non-data private caches, and the third group includes dirty or exclusive caches.

### FIELD OF DISCLOSURE

Disclosed aspects are directed to power management policies and architectures thereof for memory structures. More specifically, exemplary aspects are directed to power management based on allocation policies for memory structures.

### BACKGROUND

Modern processors have ever increasing demands on performance capabilities. To meet these demands, integrated circuits for processors are being designed with high performing standard cells and memories, which have the adverse effects of higher dynamic and leakage power. Since different components of the processors may have different performance demands and can tolerate different latencies, processor architectures may employ different types of standard cells and cell libraries to meet these performance and latency considerations. For instance, high performing standard cells may exhibit low latency characteristics, but may suffer from high dynamic and leakage power. Similarly, low performance standard cells may have higher latencies but be more power efficient.

Furthermore, different power modes may be employed for different types of components based on their desired performance and latency metrics, for example, when switching between power states. For instance, some high performance components such as central processing units which may be woken up from a standby or low power state based on an interrupt or qualifying event may have low latency demands, and so their power modes may be controlled using architectural clock gating techniques, which may not result in high power savings. Memory structures such as L1, L2, L3 caches, etc., may be placed in a retention mode by reducing their voltage supply and also collapsing peripheral logic controlling them, which would incur higher latencies to exit the retention mode but may have higher power savings. Furthermore, some components may be completely power collapsed in low power states, thus involving high latencies but also leading to high power savings.

Among the various above-described options, CPU private caches are conventionally organized into a L1-I instruction cache (L1 I-cache), L1-data cache (L1 D-cache) and L2 unified instruction and data cache (which may be shared or private). Other memory structures may include a memory management unit (MMU) and specifically a translation lookaside buffer (TLB), prefetch buffers, history buffers, etc. The I-cache, TLB, prefetch, and history buffers are conventionally read-only clean data structures and the D-cache may support dirty data (e.g., read-modify-write). So for memory structures such as a D-cache, a full flush of the data therein may be involved prior to a power collapse.

Power multiplexers for memory arrays, or array power muxes (APMs) may be used for switching between high and low voltage supplies to be delivered to the above memory structures, e.g., to provide higher voltage to meet turbo mode frequency criteria. APMs may also have the circuitry to provide a diode-drop voltage, which provides a retention voltage to the respective memory structures during the above-described retention modes.

Furthermore, it is also recognized that allocation policies may differ for the various above-described memory structures. In a strictly inclusive allocation policy, cache lines are always allocated to both a lower level cache (e.g., a smaller size L1 cache) and a higher level cache (e.g., a L2 unified of larger size). A strictly inclusive policy is commonly utilized for an L1 I-cache and L2 unified cache combination, wherein the L1 I-cache is made inclusive to the L2 unified cache to have reduced arbitration on the L1 I-cache access from snoops from other cores, so as not to stall the execution pipeline, while also displaying low latencies for improved snoop performance Since the instruction region in a memory may be shared among multiple processor cores in a shared programming model, the inclusive property described above may lead to better performance in the event that frequent snoops between the cores occur (e.g., the L2 cache can service a snoop faster without arbitrating access on the L1 cache of the processor core which is snooped, as the L1 cache may be busy with execution of commands directly from the processor core). For some higher performance systems, even the L1 D-cache may be made strictly inclusive with a write-through to the L2 cache, for similar considerations discussed above.

In a second allocation policy, which is a strictly exclusive policy, the allocation of cache lines may be mutually exclusive between lower and higher levels of caches. For instance, the same cache line is not allowed to be present in both a lower and a respective higher level of cache at the same time instance. This allocation policy works on the principle of swapping, i.e., filling a line from a higher level cache effectively exchanges an evicted line from a lower level cache. In the case of an L1 D-cache, for example, a strictly exclusive policy would make the lines of the L1 D-cache exclusive to the respective L2 cache, which may lead to the benefit of creating more storage space for the data to be cached; however, making the L1 D-cache inclusive, as previously indicated, would help with improved performance, but at the cost of lower data storage capacity, which may be a tradeoff worth exploring for high performance CPU architectures.

A third allocation policy is in between the above two policies and may be referred to as a pseudo or partial inclusive or exclusive policy. In this case, no strict rule is enforced for maintaining the same copy of data in both level of caches, for example, and likewise, no strict rule is enforced for maintaining exclusivity between the different level of caches.

With the above cache allocation policies in mind, it is recognized that inclusiveness of data is effectively creating data redundancy. When such inclusiveness is enforced, there is a potential for power savings improvement, without suffering from loss of information or loss of snoop performance However, conventional implementations are not seen to exploit inclusiveness in an effective manner to realize such benefits, as will be explained further below.

As previously explained, a standby mode implemented using clock gating techniques does not lead to significant power savings, while a retention mode with limited power collapse and reduced voltage operation may improve power savings at the cost of performance, degraded snoop hits, etc., in a multi-core processing environment. On the other hand, while a fully power collapsed mode, where possible, may lead to longevity of power or days of use (DoU), this would be at the cost of high wake-up latency and time and power hungry flush operations.

However, as noted above, the caches which are private to a processor core (e.g., L1 I-cache, L1 D-cache) are conventionally single/low cycle, high performance memories, which means that their implementations tend to be more expensive in terms of leakage power because leakage is proportional to voltage supplied on memory rails (which may be in a nominal/low power mode or a high/turbo mode). Even in the case of other private memory structures like dedicated MMU TLBs, prefetch buffers, branch predictors, history buffers, etc., a similar high leakage issue is possible, since these private memory structures need not be retained in full power-up condition, e.g., during a standby mode of the respective processor core, as these memory structures are not required to service the snoops from other processor cores.

Correspondingly, there is a recognized need for improved implementations and techniques for reducing power consumption of components of a processing system, e.g., to realize higher power savings during standby mode, without incurring snoop performance hits. There is also a need for increasing snoop performance in conventional retention modes and reducing the wastage of power on high performance leaky memories during standby mode. There is no known intermediate mode between the above described “standby”, “full retention” and “power collapsed” modes for private caches, and thus there is also a need for improved flexibility in this regard to balance tradeoffs between power and performance

### SUMMARY

Exemplary aspects of the invention are directed to systems and methods for memory power management based on allocation policies of memory structures of a processing system. The processing system is placed in a low power state which includes one or more of a first, second, or third low power modes. In the first low power mode, for a first group of memory structures, periphery circuitry and memory cores are power collapsed. In the second low power mode, for a second group of memory structures, periphery circuitry is power collapsed and a retention voltage is provided to memory cores. In the third low power mode, a third group of memory structures are placed in an active mode. The first group includes strictly inclusive private caches, the second group includes non-data private caches, and the third group includes dirty or exclusive caches.

For example, an exemplary aspect is directed to method of memory power management, the method comprising entering a low power state for a processing system and placing one or more groups of memory structures of the processing system in one or more low power modes. The one or more low power modes comprising a first low power mode, wherein, for a first group of memory structures, periphery circuitry and memory cores are power collapsed; a second low power mode, wherein, for a second group of memory structures, periphery circuitry is power collapsed and a retention voltage is provided to memory cores; and a third low power mode, wherein a third group of memory structures are placed in an active mode.

Another exemplary aspect is directed to an apparatus comprising a processing system; and a power manager configured to place the processing system in a low power state wherein one or more groups of memory structures of the processing system are placed in one or more low power modes. The one or more low power modes comprise a first low power mode, wherein, for a first group of memory structures, periphery circuitry and memory cores are power collapsed; a second low power mode, wherein, for a second group of memory structures, periphery circuitry is power collapsed and a diode-drop voltage is provided to memory cores; and a third low power mode, wherein a third group of memory structures are placed in an active mode.

Yet another exemplary aspect is directed to an apparatus comprising a processing means and means for placing the processing means in a low power state. The low power state comprises one or more low power modes including a first low power mode, wherein, for a first group of memory structures, periphery circuitry and memory cores are power collapsed; a second low power mode, wherein, for a second group of memory structures, periphery circuitry is power collapsed and a retention voltage is provided to memory cores; and a third low power mode, wherein a third group of memory structures are placed in an active mode.

Yet another exemplary aspect is directed to a non-transitory computer-readable storage medium comprising code, which when executed by a processor, causes the processor to perform operations for memory power management. The non-transitory computer-readable storage medium comprises code for placing a processing system in a low power state, and in the low power state, code for placing one or more groups of memory structures of the processing system in one or more low power modes including: a first low power mode, wherein, for a first group of memory structures, periphery circuitry and memory cores are power collapsed; a second low power mode, wherein, for a second group of memory structures, periphery circuitry is power collapsed and a retention voltage is provided to memory cores; and a third low power mode, wherein a third group of memory structures are placed in an active mode.

### BRIEF DESCRIPTION OF THE DRAWINGS

The accompanying drawings are presented to aid in the description of aspects of the invention and are provided solely for illustration of the aspects and not limitation thereof.

FIG. 1A illustrates a processing system with different power rails, according to aspects of this disclosure.

FIG. 1B illustrates head switches and power multiplexers for supplying power to the processing system of FIG. 1A, according to aspects of this disclosure.

FIG. 2 illustrates an exemplary apparatus configured for power management based on allocation policies of memory structures of a processing system, according to aspects of this disclosure.

FIG. 3 illustrates state transitions for a power management finite state machine (FSM), according to aspects of this disclosure.

FIG. 4 illustrates an exemplary method of power management based on allocation policies of memory structures in a processing system, according to aspects of this disclosure.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to power management techniques, e.g., implemented in a processing system for controlling power management apparatus such as APM controllers, to implement exemplary auto-low power modes as described herein. An exemplary system register is configured with power settings before a processor core or components thereof to enter a standby or low power state (wherein the processor core may be woken by an interrupt (e.g., wait for interrupt, “WFI”, standby) or woken up by an event (e.g., wait for event, “WFE”, standby). The configuration of the system register enables entry into the exemplary auto-low power mode. The controls for enabling such modes may be implemented as part of the instruction set architecture (e.g., novel operation codes or “opcodes” for the WFI/WFE standby modes).

The following aspects are directed to exemplary low power modes which are designed to avoid or mitigate performance hits, such as snoop performance hits. A power profiling of the processor core may be performed a priori, based on which, an operating system (OS) for the processing system may determine the average idle time that the processor core or an idle thread thereof may reside in the standby mode. Based on this idle time period, an auto entry to the low power mode may be selected and programmed into the system register.

In exemplary aspects, based, for example, on the system register configuration, one of either collapse mode or retention mode may be selected on read-only memory structures. Thus, based on power/wake-up latency profiles, software or the OS may improve the DoU.

In some aspects, the above implementations may involve grouping the memory structures of a processing system among the following groups. For private caches (including private MMU TLBs, prefetch buffers, history buffers, etc.), at least the following three groups are disclosed, with respective low power states designed to maximize power savings and performance

In a first group or “group 1” the APM controller, based on the system register configuration, may trigger or effect power collapse on strictly inclusive low level private caches, such as L1 caches (e.g., L1 I-caches in some examples). This power collapse would involve power collapse of both memory periphery circuitry and a bit cell core of the respective memory structures. It is recognized that despite the power collapse, no loss of information will be incurred because the private low level caches (e.g., L1 cache) is inclusive to higher level caches (e.g., L2 cache).

In a second group or “group 2”, the APM controllers may cause the APMs to enter a deep retention mode for “non-data” private caches or memory structures (e.g., private MMU TLBs, history buffers, etc., of a processor core). This mode would involve collapsing the memory periphery circuitry and using existing APM tiles to provide a diode-drop voltage, which provides a retention voltage to the memory bit cell core. The retention voltage supplied to the memory bit cell core results in a reduced voltage supply and leads to higher leakage power savings on the memory bit cell core. It is recognized that the group 2 memory structures are not inclusive, and previous memory/history is retained for group 2. For instance, during the exemplary low power mode , the previous history of TLBs, prefetch buffers, branch prediction tables, etc., are retained, which helps in performance upon subsequent wake up of the processor core. However, software options may be provided to power collapse these read only structures without retention if desired.

In a third group or “group 3” memory structures, dirty/exclusive caches are kept active so as to not affect performance of snoops from other processor cores, for example. An exclusive cache may either be, for example, a unified L2-cache only (if the respective L1 D-cache—in addition to L1-I cache—is also strictly inclusive with write-through caches) or a combination of a L2-cache and L1 D-cache if the L1 D-cache is exclusive in the processing system.

In further aspects, at least three different memory array sequencers (MAS) may be provided within the APM controller to manage the above-disclosed three groups of memories. Corresponding clock gating structures may also be provided to manage low power modes.

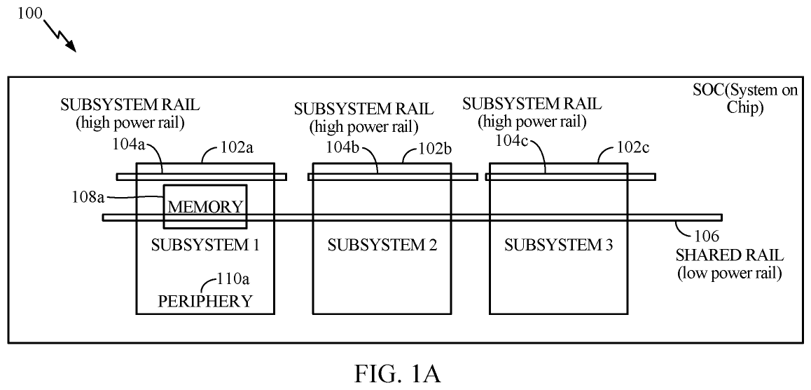

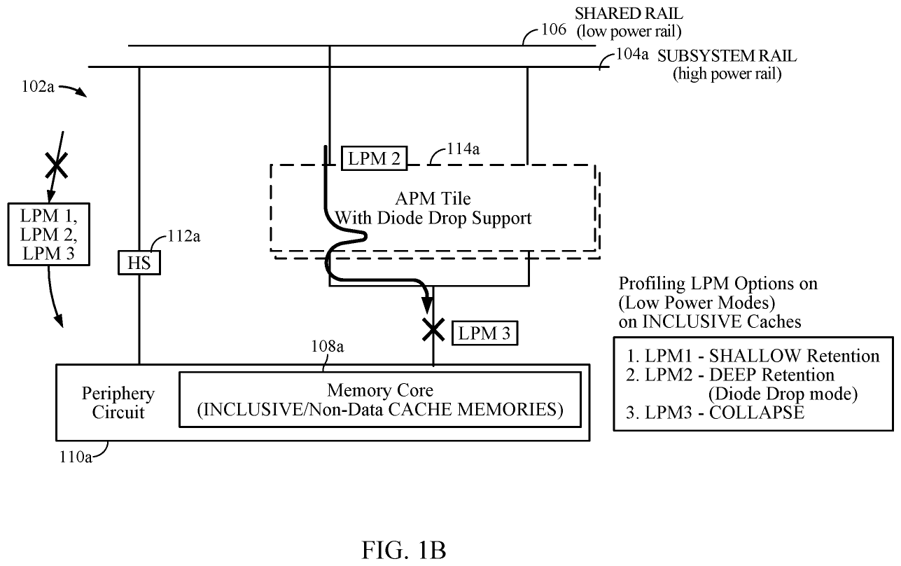

FIGS. 1A-B illustrate aspects of different power rails and related power muxes for delivering power to components/subsystems in integrated circuits. FIG. 1A shows processing system 100 which may be a system on chip (SoC) in an example, with processing system 100 comprising at least the three subsystems identified with reference numerals 102a-c. Each one of the subsystems 102a-c may include a variety of functional logic without loss of generality. The memory instances in subsystems 102a-c, e.g., memory 108a, may be connectable to and configured to be powered by a shared power rail denoted as shared rail 106. Subsystems 102a-c may also have respective dedicated power rails denoted as respective subsystem rails 104a-c to supply power to standard logic cells in the respective subsystems 102a-c.

Accordingly, in an implementation wherein subsystem 102a comprises memory 108a and peripheral logic 110a (e.g., comprising read/write circuitry for memory 108a), at least two power modes may be provided, wherein, in a high power/turbo mode, memory 108a may be coupled to the high power subsystem rail 104a, while in a nominal or low power mode, memory 108a may be coupled to the low power shared rail 106. In an example, memory 108a may comprise several memory instances. Although not shown in this view, but discussed with reference to FIG. 1B below, one or more power muxes may be used in switching the connection of the plurality of memory instances of memory 108a from subsystem rail 104a to shared rail 106, or from shared rail 106 to subsystem rail 104a. The number of power muxes/APM tiles which may be provided for each of the previously mentioned memory array sequencers (MASs) may depend on a current-resistance (IR) drop or load requirement of the set of memory instances controlled by that MAS. While the plurality of memory instances of memory 108a may be connectable through the power muxes to an active rail of the two or more power rails as above, peripheral logic 110a may not be similarly connectable to different power rails, but only connectable to the dedicated high power subsystem rail 104a, and so power muxes may not be present between peripheral logic 110a and subsystem rail 104a. To explain further, while the dedicated subsystem rail 104a may power-up the entire subsystem 102a, logic therein such as a central processing unit (CPU) subsystem's logic, may be much larger than memory 108a. Peripheral logic 110a may be part of the CPU subsystem which may be placed around memory 108a, and comprise read-write circuitry, row/column address decoders, etc. Correspondingly, peripheral logic 110a may be powered only by subsystem rail 104a and not shared rail 106.

With reference now to FIG. 1B, additional details of one subsystem, e.g., subsystem 102a have been shown, with power switches, such as head switches (or other means for turning on/off power supply) for enabling powering up or powering down of the functional logic. For peripheral logic 110a, head switches (HS) 112a may be provided in a path between peripheral logic 110a and subsystem rail 104a, such that turning off head switches 112a will result in powering off the respective peripheral logic 110a. For memory instances in memory 108a (e.g., comprising inclusive non-data cache memories), power muxes such as APM 114a are shown, which may flexibly connect memory 108a to shared rail 106 or to subsystem rail 104a. APM 114a may further provide diode drop between the voltage of shared rail 106 for the low power modes described herein.

For the above-described three groups of memory, three different low power modes or LPMs of operation are described herein and referred to as a first low power mode or LPM1 (or shallow retention mode), second low power mode or LPM2 (or deep retention mode wherein a diode drop voltage is provided), and third low power mode or LPM3 (or power collapse mode). For all three of the above low power modes, LPM1, LPM2, and LPM3, head switches 112a may be turned off. For the second low power mode or LPM2 wherein memory 108a is placed in a deep retention mode, APM 114a may be configured to connect memory 108a to low power shared rail 106, while also providing a diode drop voltage. For the third low power mode or LPM3, memory 108a may also be power collapsed by APM 114a configured to disconnect memory 108a from either power rails, subsystem rail 104a and shared rail 106.

With the above configuration in mind, one implementation is described wherein power profiling may be performed, e.g., using simulation data and software assimilation and analysis, to determine which one of the three LPMs is best suited for a particular memory type. For example, for a grouping wherein group 1 comprises L1 I-cache read only inclusive low level caches and group 2 comprises non-data read only memories, a hybrid mode may be chosen wherein LPM3 is selected for group 1 and LPM2 is selected for group 2, e.g., for a desired balance of power and performance considerations. These and various other selections of specific LPMs for the memory types will be explained in the following sections in further detail.

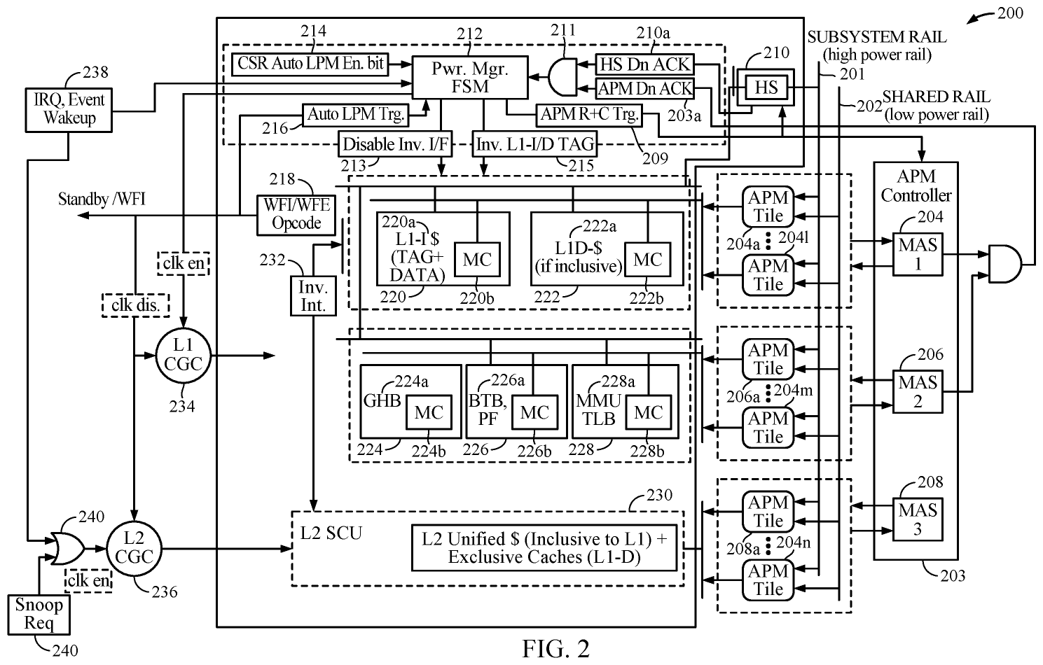

Referring now to FIG. 2, processing system 200 according to an exemplary aspect is shown. Once again, two power rails, such as a first power rail or high power rail or subsystem rail 201 and a second power rail or low power rail or shared rail 202 may be provided for selectively supplying power to the various components of processing system 200. In processing system 200, memory structures therein are grouped into the above-described three groups, based for example, on their allocation policies, and memory array sequences (MAS) are disclosed for selectively and controllably supplying power to these groups based on respective low power modes of operation.

In further detail, FIG. 2 shows two power rails, a first power rail which may be a high power rail such as a subsystem rail and designated by the numeral 201, and a second power rail which may be a low power rail such as a shared rail and designated by the numeral 202. System register 214 may be programmed with low power modes (e.g., LPM1, LPM2, LPM3) and other related power settings for processing system 200. Power manager finite state machine 212 (hereinafter, “FSM 212”) receives the settings from system register 214, and in conjunction with other inputs and signals which will be described in the following sections, provides control 209, e.g., for APM retention and power collapse triggers to APM controller 203.

APM controller 203 implements the LPMs for the various memory structures of processing system 200. In this regard, APM controller 203 is shown to comprise at least three memory array sequencers (MAS), shown as MAS1 204, MAS2 206, and MAS3 208. Various APM tiles are shown, coupled to APM controller 203, e.g., configured to switch between high power rail 201 and low power rail 202, and also additionally provide a diode drop voltage in some instances as described in FIG. 1B. Each one of the three MASs 204-208 may control one or more APM tiles. Specifically, a first set of APM tiles 204a-1 may be controlled by MAS 1 204, a second set of APM tiles 206a-m may be controlled by MAS2 206, and a third set of APM tiles 208a-n may be controlled by MAS3 208.

While processing system 200 may comprise various types of memory structures, the following three groups have been identified according to an aspect of this disclosure. The groups may be powered through respective APM tiles, which are controlled by respective MASs.

For instance, the first group or group 1 memory structures, such as inclusive read only caches (for a processor core not specifically shown) may comprise L1 I-cache 220, which may include tag and data. If an inclusive L1 D-cache 222 is present, as shown, this is also classified under group 1. L1 I-cache 220 may include periphery 220a and memory core 220b. Similarly, the inclusive L1 D-cache 222 may include periphery 222a and memory core 222b. For group 1, as previously noted, a power collapse would involve power collapse of both peripheries 220a, 222a and memory cores 220b, 222b. Thus, head switches 210 may be utilized for turning off power supply to peripheries 220a, 222a from high power subsystem rail 201, and APM tiles 204a-1 may be configured to collapse power to memory cores 220b, 222b by shutting off power supply from both high power rail 201 and low power rail 202 to bit cells in memory cores 220b, 222b. It is recognized that despite the power collapse, no loss of information will be incurred because the respective L1 I-cache 220 and L1 D-cache 222 are inclusive to higher level caches (e.g., L2 cache 230 which will be discussed further below).

The second group or group 2 memory structures include, for example, non-data read only memories, such as global history buffer (GHB) 224, prefetch history table (PHT) 226, and MMU TLB 228. Each of these group 2 memory structures include respective peripheries 224a, 226a, and 228a and respective memory cores 224b, 226b, and 228b. For these group 2 memory structures, MAS2 206 may control APM tiles 206a-m to place the group 2 memory structures in a deep retention mode. As previously mentioned, in the deep retention mode, peripheries 224a, 226a, and 228a may be collapsed, e.g., by heads switches 210, and APM tiles 206a-m may be configured to provide a diode-drop or retention voltage from low power rail 202 to respective memory cores 224b, 226b, and 228b. In this manner, voltage supply is reduced in the deep retention mode, which achieves higher leakage power savings. Since the group 2 memory structures GHB 224, PHT 226, and MMU TLB 228 are not inclusive, the retention voltage is sufficient for retaining their previous memory/history in the deep retention mode, which helps achieving desired performance upon their subsequent wake up. It is noted that power collapse of any one or more of memory cores 224b, 226b, or 228b is also possible by configuring respective APM tiles 206a-m to shut off power supply from both low power rail 202 and high power rail 201 to the corresponding memory cores 224b, 226b, or 228b if retention is not desired or needed.

The third group or group 3 memory structures include dirty/exclusive caches, such as unified L2 cache 230 which is inclusive to the above-described L1 caches. Although not shown, if there is an exclusive L1 D-cache present in the processing system 200, it may be classified under group 3. Group 3 memory structures are retained in active mode, by enabling head switches 210 to retain power connection to high power rail 201 for respective peripheries, and through the control of MAS3 208 to enable respective APM tiles 208a-n to retain connection to one of low power rail 202 or high power rail 201.

Additionally, in processing system 200, separate clock gate control (CGC) structures such as a first clock gating control L1 CGC 234 and a second clock gating control L2 CGC 236 are provided. In the event of snoop 240, for the processor for which the memory structures are shown (e.g., received from another processor or core which has a shared memory programming model with the processor) L2 CGC 236 may be configured, e.g., clock ungated, along with other snoop control logic, for enabling the snoop requests (e.g., data snoop requests) and servicing the snoop requests, for the group 3 memory structures (controlled by MAS3 208), while the group 3 memory structures are in the active mode. L1 CGC 234 may be configured, e.g., gated, for disabling the waking-up of the group 1 and the group 2 memory structures (controlled by respective MAS 1 204, MAS2 206) for instruction and data snoop requests.

As previously mentioned, FSM 212 is configured to provide the controls for APM controller 203. In general, FSM 212 controls the entering or exiting of the low power state of processing system 200 (comprising the first, second, and third low power modes) based on one or more trigger or handshake events, statuses from head switches controlling power to the periphery circuitry of the first group and the second group, and statuses from memory array sequencers for controlling power to the memory cores of the first group and the second group.

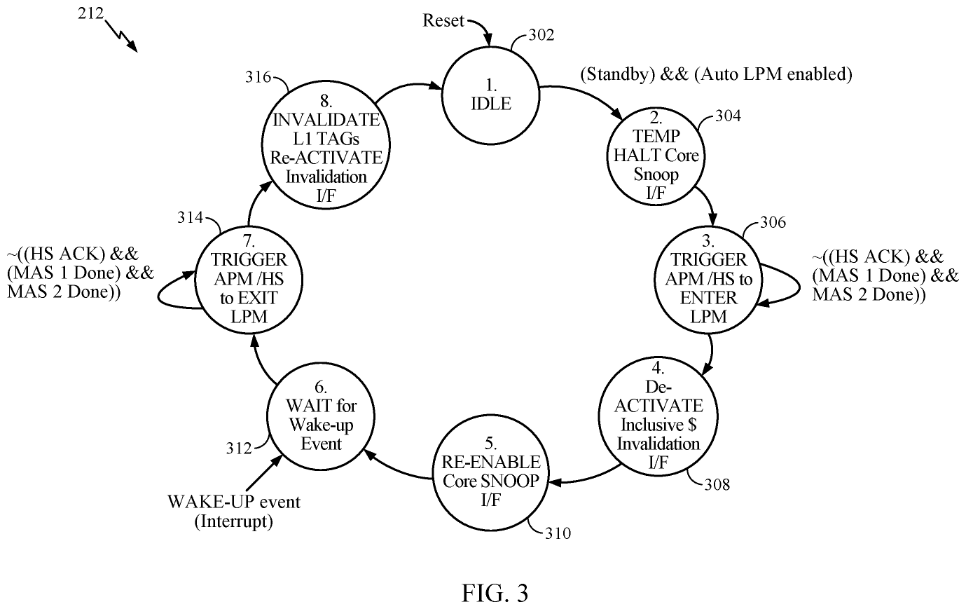

FIG. 3 illustrates an example sequence and state transitions for the FSM implemented by FSM 212. The following description makes combined references to FIGS. 2-3.

In exemplary aspects herein, respective memory structures are woken up based on events and inputs. The wake-up events include an Interrupt, WFE events or a MMU-TLB Invalidate (if MMU TLB 228 is present), etc. An invalidation of L1 I-cache 220 may accompanied with the MMU-TLB Invalidate (the L1 I-cache 220 may already power collapsed). Furthermore, prefetch and branch predictor buffers, e.g., GHB 224, PHT 226 may also be invalidated when the MMU-TLB Invalidate is received, since these prefetch and branch predictor buffers may retain information from prior instructions. Alternatively, the MMU-TLB Invalidate may be provided in the form of a special snoop operation which is decoded as a wake-up event for FSM 212.

The wake-up events do not include data/instruction snoops received by the processor of FIG. 2, which leads to significant reduction in leakage power. For power collapse of inclusive L1 caches (e.g., group 1 memory structures) the respective tags are invalidated upon wake-up, which means that corresponding instructions/data are read from L2 cache 230 upon wake up and then subsequently allocated respectively to L1 I-cache 220 or L1 D-cache 222 during the course of execution of instructions in the processor after power-up.

Accordingly, FSM 212 utilizes the signal shown as auto-LPM trigger 216 which is derived from the WFI/WFE opcode 218 to traverse the various FSM states. In this regard, handshake mechanisms with head switches 210 used for periphery circuitry of group 1 and group 2 memories is also provided through the signal, HS done ack 210a. Handshake with MAS1 204 and MAS2 206 is also accomplished through the signal APM done ack 203a from APM controller 203, providing a representation that power management operations by MAS 1 204 and MAS2 206 have been completed.

FSM 212 is also configured to disable an invalidation snoop interface 232, if present between the group 1 (e.g., L1) and group 3 (e.g., L2) memory structures. Once the group 1 memory structures are powered up from power collapse mode effected by MAS1 204, FSM 212 also operates to reset and invalidate the tags in L1 I-cache 220 and/or the contents of L1 D-cache 222, as will be further explained below.

Referring to FIG. 3, upon reset, FSM 212 enters IDLE 302. In the following states, it is recognized that in the aforementioned LPM modes, the corresponding groups 1-3 of memory structures are caused to wake-up for wake-up events. For the first and second groups 1-2 of memory structures, waking-up is disabled for any type of snoop requests, whether they are for instructions or for data. However, data snoop requests may remain enabled for the third group 3.

Thus, if a standby mode is determined from auto-LPM trigger 216 and auto-LPM mode is enabled for processing system 200, TEMP HALT SNOOP 304 is entered, wherein snoop monitoring/servicing is disabled while LPM transition is completed based on FSM 212 (e.g., an ongoing snoop request may be allowed to complete and subsequently a related snoop interface may be temporarily disabled for new snoop requests, which would ensure that new snoop requests do not remain pending stalled for greater than a short time period until the LPM transitions have been completed).

Subsequently, FSM 212 enters the state, TRIGGER APM/HS to ENTER LPM 306, wherein respective APM controller 203 and head switches 210 are caused to undertake operations for placing respective group 1 and group 2 memory structures in the aforementioned LPM1 and LPM2 states. Specifically, MAS 1 204 causes respective group 1 memory cores 220b, 222b to enter power collapse, MAS2 206 causes respective group 2 memory cores 224b, 226b, and 228b to be placed in deep retention; and head switches 210 cause all of the peripheries 220a-228a of group 1 and group 2 memory structures to be power collapsed. FSM 212 remains in TRIGGER APM/HS to ENTER LPM 306 while waiting for both the assertion of HS done ack 210a and APM done ack 203a, until AND gate 211 provides an assertion for FSM 212 to move to the next FSM state 308.

In the subsequent state, De-ACTIVATE Inclusive Cache Invalidation Interface 308, invalidation snoop interface 232 is disabled.

In state RE-ENABLE SNOOP I/F 310, snooping is re-enabled and state WAIT for WAKE-UP EVENT 312 is entered wherein power manager FSM 212 waits until a wake-up event is received (e.g., an interrupt).

Once woken up, FSM 212 enters TRIGGER APM/HS for LPM EXIT 314, to exit the LPM mode. FSM 212 remains in TRIGGER APM/HS for LPM EXIT 314 until an indication of HS done ack 210a and APM done ack 203a are received, i.e., head switches 210 are re-enabled to supply power and APM tiles 204a-1 and 206a-m are likewise also re-enabled through respective MAS 1 204 and MAS2 206.

Upon wake up and return to non-LPM modes, INVALIDATE INCLUSIVE CACHE TAGs Re-ACTIVATE INCLUSIVE CACHE INVALID INTERFACE 316 are entered, wherein the previously power collapsed caches are reset and invalidated and the invalidation snoop interface 232 is re-enabled.

Accordingly, FSM 212, in conjunction with memory array sequencers MAS1 204, MAS2 206, and MAS3 208 implement the above-described LPM functionality. For example, respective APM tiles 204a-1, 206a-m, and 208a-n are controlled to support the power states: (1) Active, wherein APM tiles 206a-m can connect respective memory structures in their groups to high power rail 201 or low power rail 202 to support different operating modes, (2) Retention: wherein APM tiles 206a-m, for example provide the diode-drop voltage or the retention voltage, which is a reduced rated voltage corresponding to the minimum voltage required for retaining memory while reducing leakage, and (3) Power collapse: wherein power is completely cut off from both high power rail 201 and low power rail 202. Upon power-up from a standby mode, MAS1 204 and MAS2 206 are configured to restore respective memory structures under group 1 and group 2 back to current operating voltage (high power rail 201 or low power rail 202) based on a current rail status of APM controller 203.

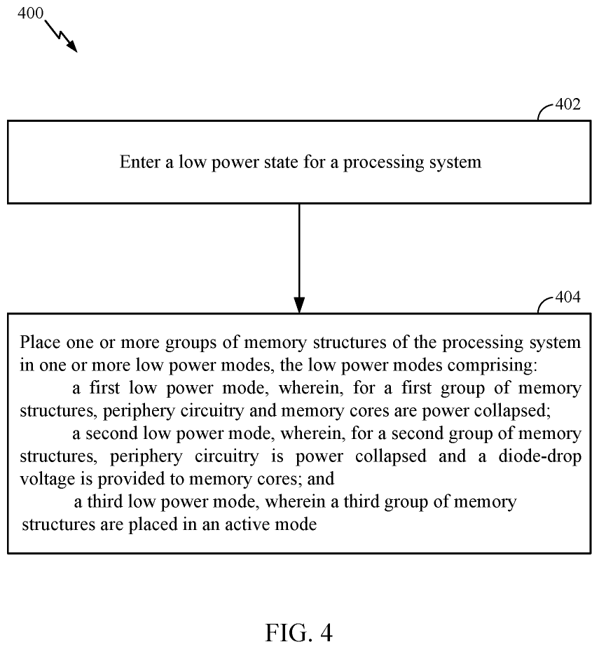

It will be appreciated that exemplary aspects include various methods for performing the processes, functions and/or algorithms disclosed herein. For example, FIG. 4 illustrates a method 400 of memory power management (e.g., in processing system 200).

Block 402 of method 400 may comprise, entering a low power state for a processing system selecting (e.g., based on FSM 212 entering state LPM 306 as explained with reference to FIG. 3).

Block 404 comprises placing one or more groups of memory structures of the processing system in one or more low power modes. The low power modes include a first low power mode (e.g., LPM1), wherein, for a first group of memory structures (e.g., group 1 memory structures such as L1 I-cache 220, L1 D-cache 222), periphery circuitry (respectively, peripheries 220a, 222a) and memory cores (respectively, memory cores 220b, 222b) are power collapsed; a second low power mode (e.g., LPM2), wherein, for a second group of memory structures (e.g., group 2 memory structures such as global history buffer (GHB) 224, prefetch history table (PHT) 226, and MMU TLB 228), periphery circuitry (e.g., respective peripheries 224a, 226a, and 228a) is power collapsed and the diode-drop or retention voltage is provided to memory cores (e.g., respective memory cores 224b, 226b, and 228b); and a third low power mode (e.g., LPM3), wherein a third group of memory structures (e.g., group 3 memory structures such as unified L2 cache 230 or an exclusive L1 D-cache) are placed in an active mode.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for power management of memory structures based on allocation policies thereof. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of memory power management, the method comprising:
entering a low power state for a processing system;
placing one or more groups of memory structures of the processing system in one or more low power modes comprising:
a first low power mode, wherein, for a first group of memory structures, periphery circuitry and memory cores are power collapsed;
a second low power mode, wherein, for a second group of memory structures, periphery circuitry is power collapsed and a retention voltage is provided to memory cores; and
a third low power mode, wherein a third group of memory structures are placed in an active mode.

2. The method of claim 1, wherein, the first group comprises strictly inclusive private caches of the processing system;
the second group comprises non-data private caches of the processing system; and
the third group comprises dirty or exclusive caches of the processing system.

3. The method of claim 2, wherein, in the first low power mode, there is no loss of information stored in the first group; and
in the second low power mode, previous information is retained in the second group.

4. The method of claim 2, wherein
the first group comprises one or more of a level 1 (L1) instruction cache or an inclusive L1 data cache;
the second group comprises one or more of a global history buffer (GHB), a prefetch history table (PHT) or a memory management unit translation lookaside buffer (MMU TLB); and
the third group comprises one or more of a unified level 2 (L2) cache or an exclusive L1 data cache.

5. The method of claim 1, comprising providing power collapse to the periphery circuitry of the first group and the second group through head switches.

6. The method of claim 1, comprising providing power collapse to the memory cores of the first group through a first set of array power multiplexer (APM) tiles, the first set of APM tiles controlled by a first memory array sequencer (MAS).

7. The method of claim 6, further comprising waking-up the memory cores of the first group by the first MAS, by configuring the first set of APM tiles to connect the memory cores of the first group to a first power line or a second power line.

8. The method of claim 1, comprising providing the retention voltage to the memory cores of the second group through a second set of array power multiplexer (APM) tiles, the second set of APM tiles controlled by a second memory array sequencer (MAS).

9. The method of claim 8, further comprising waking-up the memory cores of the second group by the second MAS, by configuring the second set of APM tiles to connect the memory cores of the second group to a first power line or a second power line.

10. The method of claim 1, comprising providing power to the memory structures of the third group, in the active mode, through a third set of array power multiplexer (APM) tiles, the third set of APM tiles controlled by a third memory array sequencer (MAS).

11. The method of claim 10, further comprising configuring the third set of APM tiles, by the third MAS, to connect the memory cores of the third group to a first power line or a second power line.

12. The method of claim 1, further comprising disabling waking-up the memory cores of the first group and the second group when instruction or data snoop requests are received, and enabling data snoop requests for the third group.

13. The method of claim 12, comprising configuring a first clock gating control for disabling the waking-up of the memory cores of the first group and the second group, and configuring a second clock gating control for enabling the data snoop requests for the third group.

14. The method of claim 1, further comprising entering or exiting the low power state based on one or more trigger or handshake events, statuses from head switches controlling power to the periphery circuitry of the first group and the second group, and statuses from memory array sequencers for controlling power to the memory cores of the first group and the second group.

15. An apparatus comprising:
a processing system; and
a power manager configured to place the processing system in a low power state wherein one or more groups of memory structures of the processing system are placed in one or more low power modes comprising:
a first low power mode, wherein, for a first group of memory structures, periphery circuitry and memory cores are power collapsed;
a second low power mode, wherein, for a second group of memory structures, periphery circuitry is power collapsed and a retention voltage is provided to memory cores; and
a third low power mode, wherein a third group of memory structures are placed in an active mode.

16. The apparatus of claim 15, wherein,
the first group comprises strictly inclusive private caches of the processing system;
the second group comprises non-data private caches of the processing system; and
the third group comprises dirty or exclusive caches of the processing system.

17. The apparatus of claim 16, wherein,
in the first low power mode, there is no loss of information stored in the first group; and
in the second low power mode, previous information is retained in the second group.

18. The apparatus of claim 16, wherein
the first group comprises one or more of a level 1 (L1) instruction cache or an inclusive L1 data cache;
the second group comprises one or more of a global history buffer (GHB), a prefetch history table (PHT) or a memory management unit translation lookaside buffer (MMU TLB); and
the third group comprises one or more of a unified level 2 (L2) cache or an exclusive L1 data cache.

19. The apparatus of claim 15, further comprising head switches configured to provide power collapse to the periphery circuitry of the first group and the second group.

20. The apparatus of claim 15, further comprising a first set of array power multiplexer (APM) tiles controlled by a first memory array sequencer (MAS), the first set of APM tiles configured to provide power collapse to the memory cores of the first group.

21. The apparatus of claim 20, wherein the first set of APM tiles are further configured to wake up the memory cores of the first group by connecting the memory cores of the first group to a first power line or a second power line.

22. The apparatus of claim 15, further comprising a second set of array power multiplexer (APM) tiles controlled by a second memory array sequencer (MAS), the second set of APM tiles configured to provide the retention voltage to the memory cores of the second group.

23. The apparatus of claim 22, wherein the second set of APM tiles are further configured to provide a retention voltage to the memory cores of the second group from a first power line or a second power line.

24. The apparatus of claim 15, further comprising a third set of array power multiplexer (APM) tiles controlled by a third memory array sequencer (MAS), the third set of APM tiles configured to provide power to the memory structures of the third group from a first power line or a second power line.

25. The apparatus of claim 15, further comprising a first clock gating control configured disable wake-up of the first group and the second group, and a second clock gating control configured to enable service of snoop requests for the third group.

26. The apparatus of claim 15, wherein the power manager is configured to enter or exit the low power state based on one or more trigger or handshake events, statuses from head switches controlling power to the periphery circuitry of the first group and the second group, and statuses from memory array sequencers for controlling power to the memory cores of the first group and the second group.

27. An apparatus comprising:
a processing means; and
means for placing the processing means in a low power state, wherein the low power state comprises one or more low power modes including:
a first low power mode, wherein, for a first group of memory structures, periphery circuitry and memory cores are power collapsed;
a second low power mode, wherein, for a second group of memory structures, periphery circuitry is power collapsed and a retention voltage is provided to memory cores; and
a third low power mode, wherein a third group of memory structures are placed in an active mode.

28. The apparatus of claim 27, wherein,
the first group comprises strictly inclusive private caches of the processing means;
the second group comprises non-data private caches of the processing means, wherein in the second; and
the third group comprises dirty or exclusive caches of the processing means.

29. A non-transitory computer-readable storage medium comprising code, which when executed by a processor, causes the processor to perform operations for memory power management, the non-transitory computer-readable storage medium comprising:
code for placing a processing system in a low power state; and
in the low power state, code for placing one or more groups of memory structures of the processing system in one or more low power modes including:
a first low power mode, wherein, for a first group of memory structures, periphery circuitry and memory cores are power collapsed;
a second low power mode, wherein, for a second group of memory structures, periphery circuitry is power collapsed and a retention voltage is provided to memory cores; and
a third low power mode, wherein a third group of memory structures are placed in an active mode.

30. The non-transitory computer-readable storage medium of claim 29, wherein,
the first group comprises strictly inclusive private caches of the processing system;
the second group comprises non-data private caches of the processing system; and
the third group comprises dirty or exclusive caches of the processing system.
